(19) United States
(12) Patent Application Publication
(10) Pub. No.: US 2011/0002024 A1
(43) Pub. Date: Jan. 6, 2011

(54) LASER CONFOCAL SCANNING MICROSCOPE AND METHODS OF IMPROVING IMAGE QUALITY IN SUCH MICROSCOPE

(75) Inventors: Jafer Sheblee, Durham (GB); Kenneth J. Bell, North Shields (GB)

Correspondence Address: TAROLLI, SUNDHEIM, COVELL & TUMMINO L.L.P., 1300 EAST NINTH STREET, SUITE 1700, CLEVELAND, OH, 44114, US

(73) Assignee: Visitech International Ltd., Sunderland (GB)

(21) Appl. No.: 12/850,913

(22) Filed: Aug. 5, 2010

Related U.S. Application Data
(62) Division of application No. 11/744,415, filed on May 4, 2007.

(30) Foreign Application Priority Data
May 5, 2006 (GB) 0608923.9

(51) Int. Cl. G02B 26/10

(52) U.S. Cl. 359/201.2

(57) ABSTRACT

According to a first embodiment the invention provides for increasing the throughput and reducing the striping due to imperfections in the microlens and/or confocal aperture arrays of a Laser Confocal Scanning Microscope by increasing the number of repeat patterns in the microlens and confocal aperture arrays to more than one, and incorporating an intensity modulation function that ensures constant integrated image intensities at the image detector independent of the instantaneous speed of scanning. According to a second embodiment the invention provides for reducing the striping in a Laser Confocal Scanning Microscope by introducing a second galvanometer mirror such that the emitted laser light beam is descanned at the image (sample) plane. According to embodiments three to five, striping in a Laser Confocal Scanning Microscope is also reduced by destroying coherency in the emitted light beam by insertion of a small angle diffuser, by flattening the Gaussian intensity distribution of the emitted laser light beam and changing the characteristics of the beam expander. According to embodiment six the invention provides for changing the degree of confocality of a Laser Confocal Scanning Microscope by inserting a mechanism that offers a range of selectable confocal aperture sizes.

### CROSS REFERENCE TO RELATED APPLICATIONS

This application is a divisional application of pending U.S. patent application Ser. No. 11/744,415 to Sheblee et al entitled “Laser Confocal Scanning Microscope and Methods of Improving Image Quality in such Microscope” having a filing date of May 4, 2007 which claims priority under 35 USC 119 to British application Number 0608923.9 filed May 5, 2006. This application claims priority from and incorporated by reference the aforesaid applications in their entirety for all purposes

The present invention relates to a laser confocal scanning microscope and to methods of improving image quality in such microscope.

### DESCRIPTION OF THE PRIOR ART

Multi-beam confocal scanning systems have some advantages over single point scanning confocal systems in that photo-bleaching and photo-toxic effects are reduced and the rate at which images are captured is increased due to the parallel scanning nature of the multi-beam technologies such as spinning discs and 2-D arrays.

The traditional spinning disc multi-beam confocal systems have evolved in different forms requiring either broad band illumination (filtered white light) or laser line illumination. These make use of the Nipkow disc principle in which a disc containing a dispersed set of apertures is rotated at speed in the illumination and emission light paths. Light passing through the apertures is focussed into the focus plane of the sample and reflected light, or fluorescent light returned from the sample is focussed back at the apertures due to the reciprocal nature of the optical system. Light that originates above and below the focal plane of the sample is out of focus at the apertures and hence is rejected by them. The light that does pass through the apertures is used to form an image of the focal plane, hence a confocal image. The smaller the aperture the narrower the confocal plane that is imaged.

Spinning disc systems that use laser illumination (FIG. 1) usually include a complementary set of microlenses; each microlens collects the illumination over a larger area than its matching aperture and focuses the collected light into a point centred on its complementary aperture thus enhancing the illumination throughput. Without microlenses the transfer of light through the apertures may be of the order of 5% or less, but with the microlenses this increases significantly. Both white light and laser illumination versions have limitations which are inherent in the spinning disc technologies.

Each spinning disc usually contains several sectors and at the fastest image capture rates only one of these sectors will be used to form the image; the next image captured will use a different sector, and thus due to the small manufacturing tolerances between the sectors there is an inherent image to image variation in intensity and possibly also of quality.

The confocal apertures (generally but not exclusively circular pinholes) in these spinning discs are fixed and a change of aperture size (to maintain the same degree of confocality at various microscope magnifications) is either impossible or requires the exchange of the spinning disc.

At image exposure times that are not integer multiples of the period of the disc revolution, or integer multiples of the time for a single sector to scan the image, there are artefacts generated in the image (due to the partial sector scans) which become more pronounced as the exposure time for each image reduces (shorter exposure times are required to obtain faster image capture rates). As the exposure time reduces, the partial sector scans become an increasing proportion of the total exposure time, making the artefacts generated by the partial scans increasingly visible. These artefacts appear as variations in brightness between those regions of the image which are correctly scanned and those which are under-scanned or over-scanned by the partial sector scan. To reduce these artefacts, synchronisation is required between the image capture device and the rotation speed of the spinning disc. With motor speed control, controlled variations of the disc rotation speed do not occur instantly, which severely curtails the choice of exposure times for sequentially captured images (a sometimes necessary condition when subsequent images are illuminated or viewed at a different wavelength or band of wavelengths). The control mechanisms for these motors and the imperfections of the mechanical elements thereof can also introduce small random variations in speed, especially if the discs are not absolutely perfectly balanced or the bearings in which the motor and/or disc rotates do not offer a uniform resistance at all points in a revolution.

The introduction of the 2-D array laser confocal scanner (see for example PCT WO 03/075070) eliminates these limitations by using a stationary set of confocal apertures with a matching stationary set of microlenses (FIG. 2). Scanning of the illumination, created by the microlenses, over the sample plane is performed by a galvanometer mirror, which de-scans the returning light from the sample plane, separates it from the excitation light by means of a dichroic (in the case of a fluorescent sample) or a beamsplitter (in the case of a reflective sample), sends it through the set of confocal apertures and then rescans it onto the imaging detector using the rear face of the galvanometer mirror, which is also a mirror surface.

Thus the galvanometer, which is a precisely controllable scanning element with fast responses, together with the scanning of the image with the same microlens and confocal aperture arrays for each subsequent scan, ensures that image to image variations due to scan speed and sector variations are eliminated. A sync pulse is generated with each scan to trigger the exposure of the image detector, which is typically but not exclusively a 2D detector such as a CCD camera or one of its variants, and ensures perfect synchronisation of scanning and detection, irrespective of the image detector exposure time and the duration of the individual scan associated with it.

The stationary confocal aperture array may be modified to incorporate a sliding plate immediately adjacent to, and parallel to, the confocal aperture array, (see for example US patent application 2005007641). The sliding plate contains arrays (for example, seven arrays) of apertures smaller than the confocal aperture array, such that a collection of arrays of different aperture sizes is present on the sliding plate and displaced from each other by a known distance.

A control system for sliding the plate enables any one of the collection of arrays to be positioned such that a selected array modifies and reduces the effective aperture size of the confocal aperture array. This provides the ability to change the aperture size to maintain confocality when a different microscope objective magnification is selected or to increase the light throughput for faster image acquisition speeds when confocality is less of an issue.

### BACKGROUND OF THE INVENTION

The 2-D array laser confocal scanner described in the prior art uses a single pattern of microlenses and confocal apertures that must scan from outside of one edge of the field of view, across the field of view, and end outside the opposite edge of the field of view. Thus the laser illumination is only present in the field of view for half of the total scan duration, reducing the overall efficiency of the system by half.

Each microlens and confocal aperture pair creates a single scanning line across the image (and sample), and due to the single repeat pattern of both the microlens and confocal aperture arrays, defects in a single microlens or single confocal aperture become evident in the captured images as a darker or brighter scan line than the immediate neighbours, giving rise to random ‘striping’.

There are also effects due to coherency between the microlens generated points of light, which through the scanning process are manifested as faintly visible repeating patterns of ‘striping’.

The Gaussian intensity distribution across the microlens array may also introduce a ‘striping’ effect into the images due to the variations in intensity between the microlenses that scan adjacent lines in the sample plane (FIG. 7).

In the selectable pinhole assembly the oil (optical fluid) required to lubricate the sliding plates (to prevent scratching of their surfaces) should match the refractive indices between the sliding plates of the selectable confocal apertures and this complicates the production of such a configuration and it is also liable to failure of the sealing components. By designing the gap between the plates such that they are prevented from coming into contact with each other it is possible to dispense with the optical fluid and use an air gap, thus eliminating a potential failure mechanism.

### SUMMARY OF THE INVENTION

The present invention provides a laser confocal scanning microscope and methods of achieving increased throughput and reduced striping due to imperfections in the microlens and/or confocal aperture arrays, of achieving reduced striping and of achieving selectable degrees of confocality.

The present invention accordingly provides a laser confocal scanning microscope comprising a laser light source for emitting laser light at one or more different wavelengths; a laser beam expander for expanding the laser beam; a first galvanometer mirror for scanning and directing the laser light beam into a scanned sample plane via a microscope and for de-scanning a return light from the scanned sample plane; an array of microlenses positioned between said laser beam expander and said first galvanometer mirror, constructed and orientated such that a single scan of the first galvanometer mirror causes each microlens of the array to trace a separate scan line across the sample plane; an array of confocal apertures, which duplicates the pattern position of said array of microlenses pre-aligned such that each confocal aperture coincides with the matching microlens in said array of microlenses; a dichromatic mirror or a beam splitter, positioned between said first galvanometer mirror and said array of microlenses for separating the return light from the incident light path and directing the return light to said array of confocal apertures; an image detector, wherein the arrangement of said array of confocal apertures and of said first galvanometer mirror is such that light transmitted by said array of confocal apertures is directed to the rear face of said first galvanometer mirror, which is also a mirror, and as a result is scanned into said image detector; a means for driving said first galvanometer mirror to scan the laser light beam emerging from said array of microlenses over the sample plane, to descan the returned light from the sample plane, and to rescan the light passing through said confocal apertures into said image detector; and one or more of the following elements: a means to modify the illumination intensity distribution over the sample scanning beams, a means to modify the coherency in the sample scanning beams, a means to reduce variations in the illumination intensity distribution in the sample plane, and a means to modify the confocality of the scanned image.

The present invention also provides a method of increasing the intensity throughput of a laser confocal scanning microscope and reducing the appearance of ‘stripes’ due to imperfections in a microlens array and/or confocal aperture array thereof, comprising increasing a number of repeat patterns in the microlens and confocal aperture arrays that are scanned over an image (and sample) plane for each captured image, and controlling an emitted laser beam intensity to maintain constant integrated intensities in an image detector while the bidirectional scanning system changes direction.

The present invention further provides a method of reducing striping in the images captured by a laser confocal scanning microscope, comprising adding a second galvanometer mirror such that a Gaussian intensity distribution of an emitted laser light is de-scanned at an image (and sample) plane, and/or destroying coherency of an emitted laser light beam by inserting a small angle diffuser, and/or flattening of a Gaussian intensity profile of an emitted laser light beam.

The present invention even further provides a method of changing a degree of confocality in a laser confocal scanning microscope, comprising adding an array of smaller confocal apertures on a sliding plate adjacent and parallel to a confocal aperture array of the laser confocal scanning microscope and spaced from it by a small air gap.

### BRIEF DESCRIPTION OF DRAWINGS

FIG. 1 Schematic of a typical Nipkow spinning disc confocal system with complementary microlens disc according to the prior art.

FIG. 2 Schematic of a 2-D array laser confocal scanning system according to the prior art.

FIG. 3a Illustration showing how an imperfection in a single pattern scan creates a strong artefact in the image.

FIG. 3b Illustration showing how an imperfection in a single pattern of a multiple pattern scan creates a weaker artefact in the image.

FIG. 4 Illustration of a current 2-D array laser confocal scan showing dead time at the end of each scan where scanning is performed bi-directionally. The array size is enlarged for clarity.

FIG. 5a Illustration of a modified 2-D array laser confocal scan showing elimination of dead time at the end of each scan where scanning is performed bi-directionally and also showing that the Gaussian illumination is also scanned over the field of view.

FIG. 5b Illustration of a modified 2-D array laser confocal scan showing elimination of dead time at the end of each scan where scanning is performed bi-directionally, and also showing that the Gaussian illumination has been descanned with the addition of a second galvanometer mirror.

FIG. 5c Simplified illustration of synchronisation between first and second galvanometer mirrors to achieve descan of the Gaussian illumination at the sample.

FIG. 6 Illustration of intensity modulation applied to maintain constant captured image intensities with changing scan speed.

FIG. 7 Illustration of extreme case of striping originating from Gaussian distribution of illumination.

FIG. 8 Illustration of the principle of selectable pinholes using a sliding plate. Only partial rows and columns of pinholes are shown for clarity. Full implementation requires that the pattern of apertures is replicated both horizontally and vertically within the fixed and sliding plates as often as required.

FIG. 9 Overall schematic of 2D array scanning confocal module including the embodiments mentioned in the text.

FIG. 9A is a depiction of the invention having a multiple number of lasers.

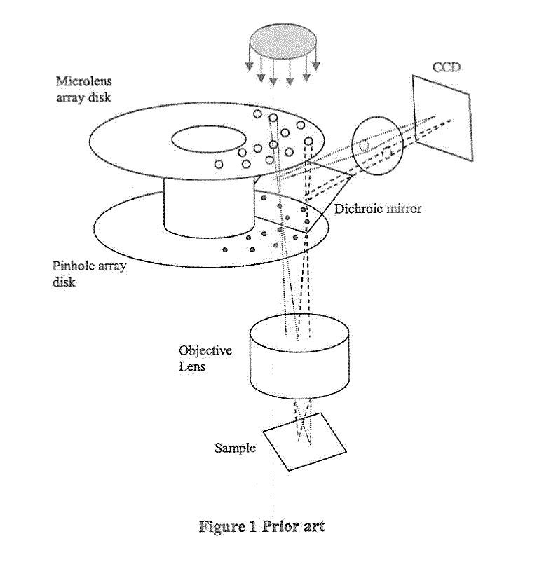

### DESCRIPTION OF PREFERRED EMBODIMENTS

Preferred embodiments of the present invention are now described by reference to the drawing.

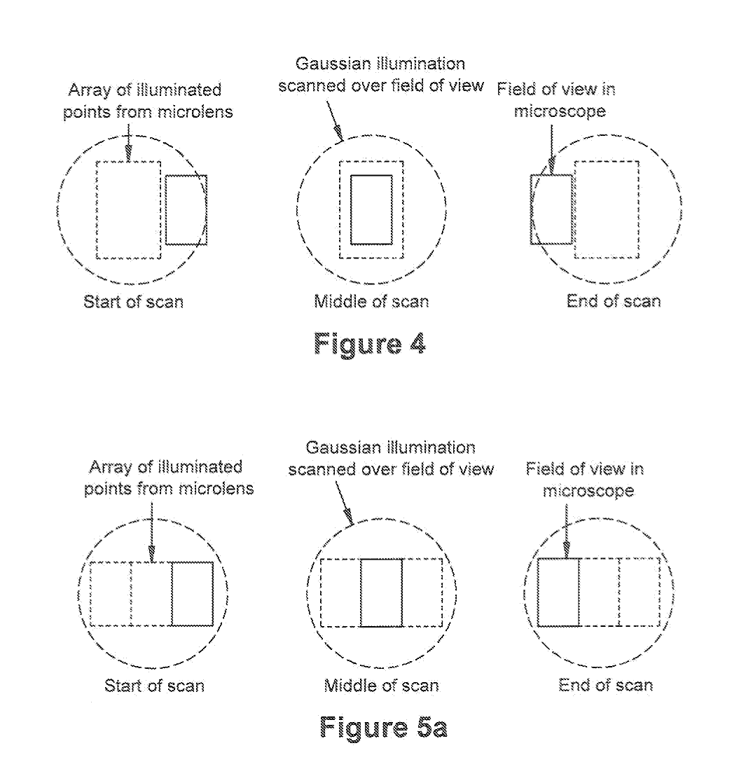

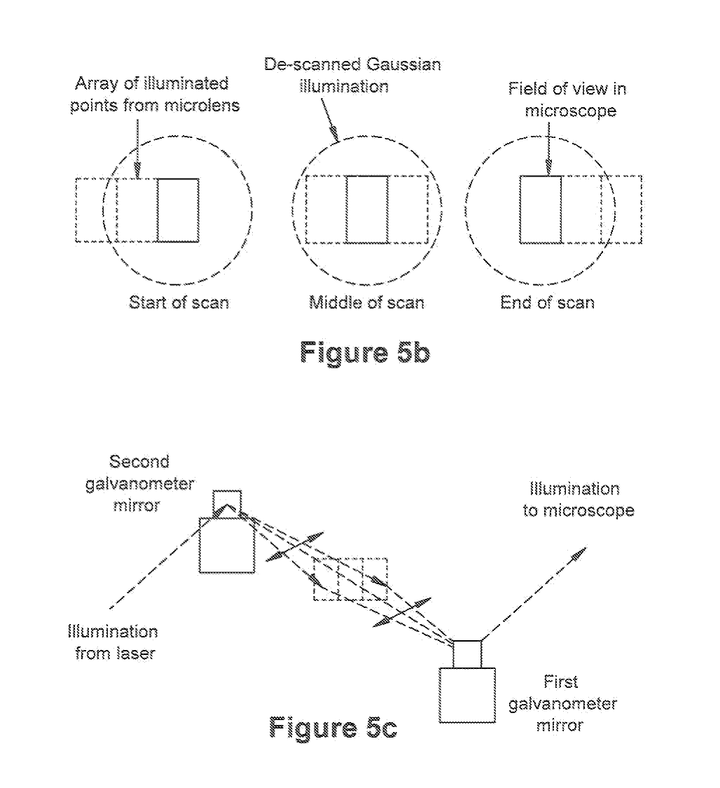

A first feature overcomes the lower throughput efficiency and reduces the random ‘striping’ due to imperfections in the microlens or aperture arrays of a 2-D array laser confocal scanner 10. This design requires additional scan patterns to be incorporated into a microlens array 12 and scanned by a galvanometer mirror 14 coupled to a motor 15 and a control 16. These additional repeat patterns along the axis of the scanning direction permit the scanning process to scan across the sample without the ‘dead’ time inherent in the original design. The patterns are arranged such that the patterns at each end of the array are fully superimposed over the field of view when the galvanometer mirror changes its scan direction. Thus it becomes possible to continuously illuminate the sample during the scanning process, without ‘dead’ time (compare FIG. 4 and FIG. 5a).

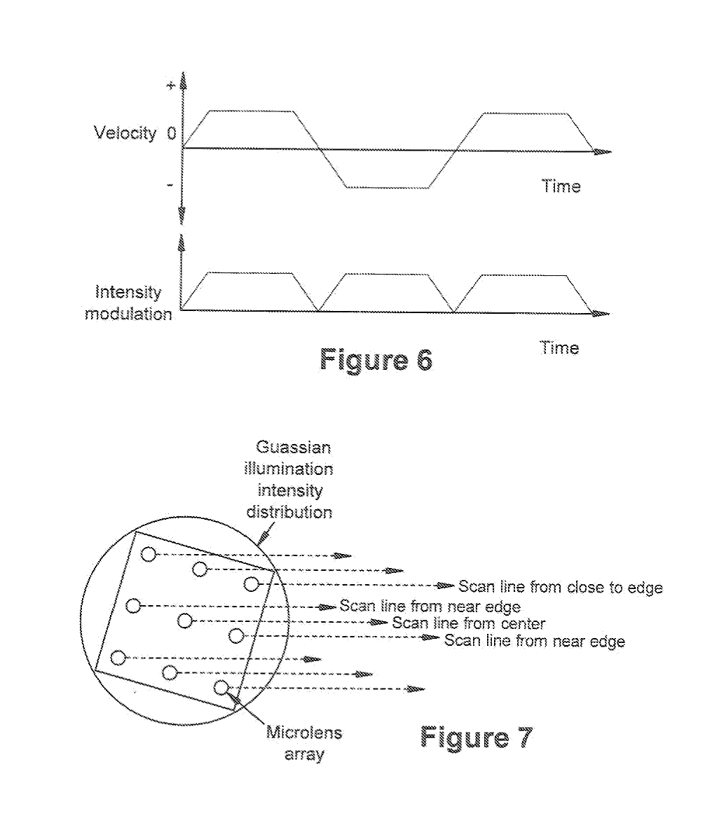

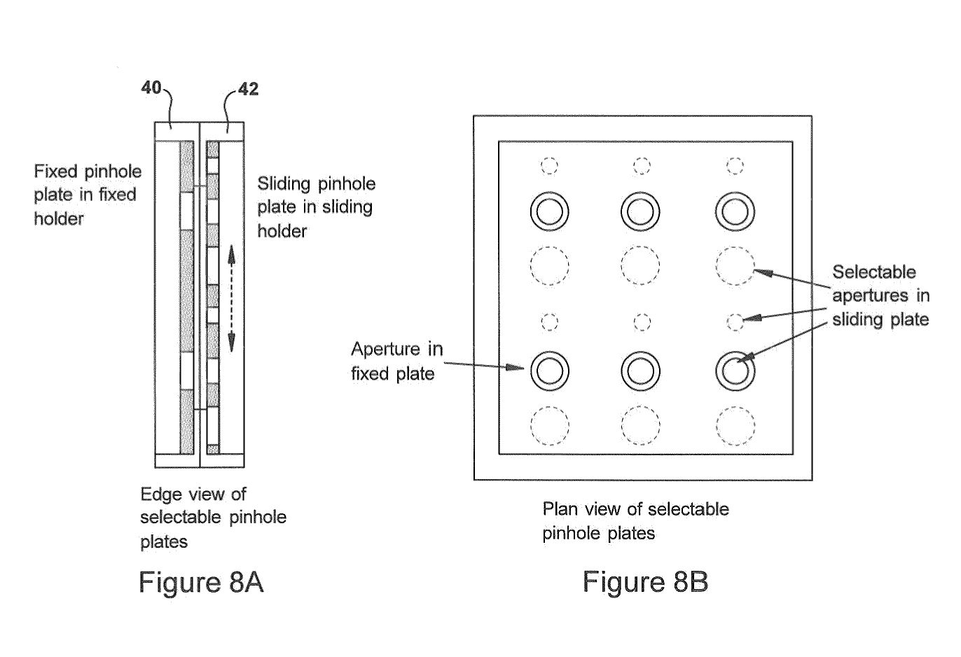

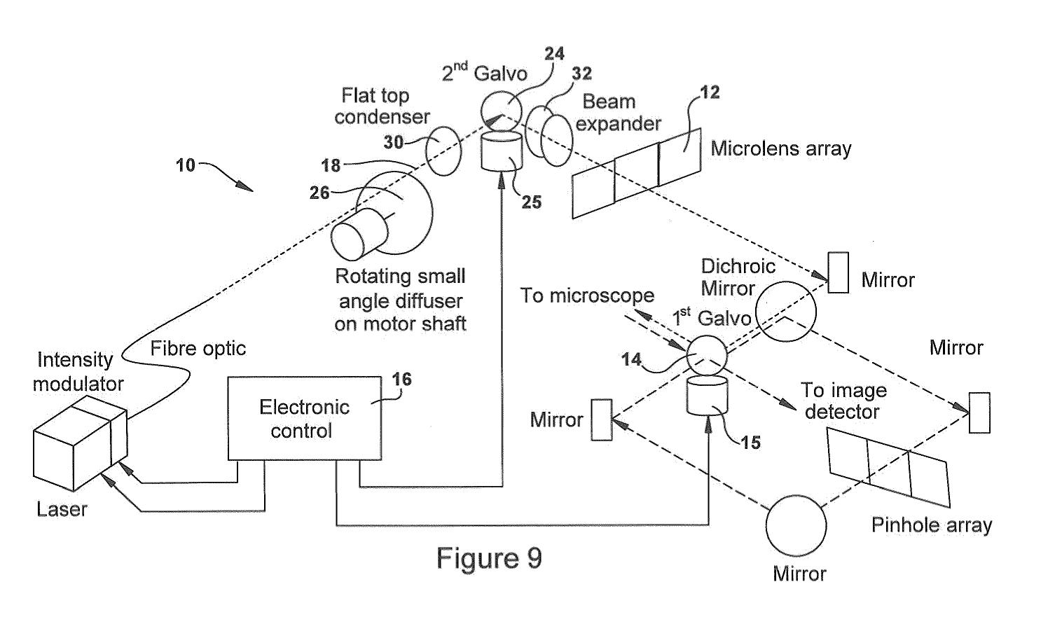

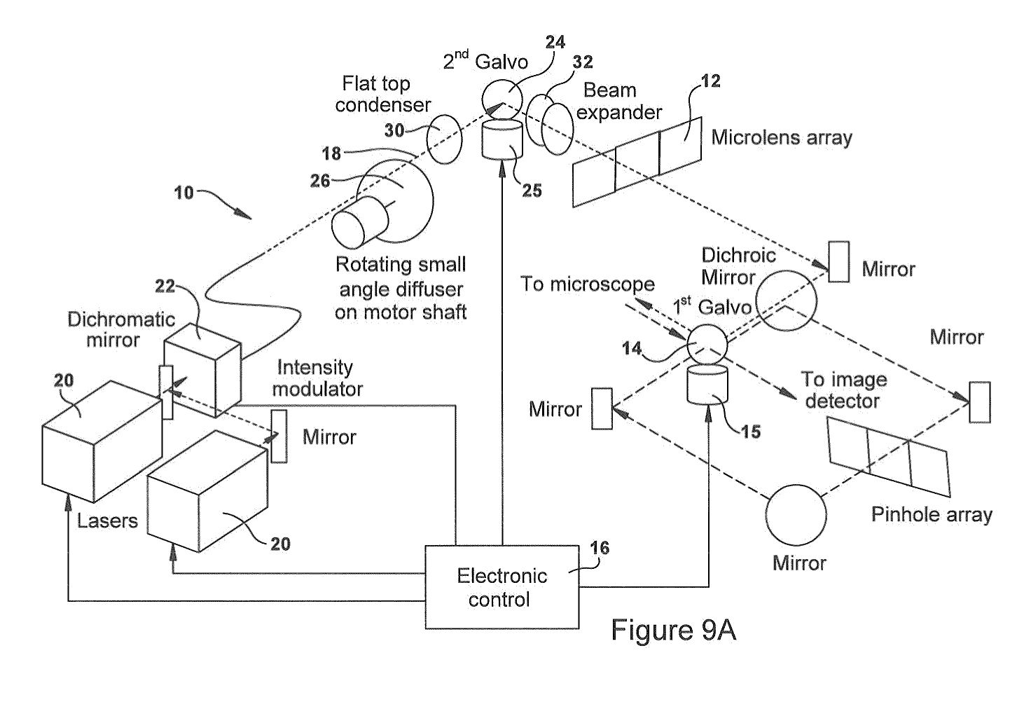

With continuous illumination of the field of view, the detected intensity during the slowing, stationary and accelerating stages of the change of scan direction will increase over the detected intensity during the steady speed portion of the scan due to the integrating nature of an image detector. This can be compensated by changing the illumination intensity of an input laser beam 18 from a laser 20. This may be achieved, for example, by using an Acousto Optical Modulator (AOM) 22, an Acousto Optical Tuneable Filter (AOTF), an adjustable micro mirror array, a neutral density filter wheel or similar equivalent acousto optical, optical, or opto-mechanical device. Taking for the purposes of illustration an AOTF, which is a device frequently included in a confocal illumination system since it permits the rapid selection of wavelengths from the input beam and deflects the selected wavelengths out of the zero order exit beam position (where they are directed into a beam dump to absorb the unwanted laser energy) to the first order beam position (where they are directed into the input of the confocal system). The AOTF also has the property of controlling the proportion of the selected wavelengths that appear in the zero and first order beams and is also able to do this at very rapid rates. The control signal waveform that drives the galvanometer mirror position is extracted and modified for use as a modulation control input signal for the wavelengths selected by the AOTF (FIG. 6). Thus the system is able to maintain the integrated intensity of the illumination as the speed of the scan varies during the change of scan direction, thus eliminating any artefacts that would arise if such control was not implemented.

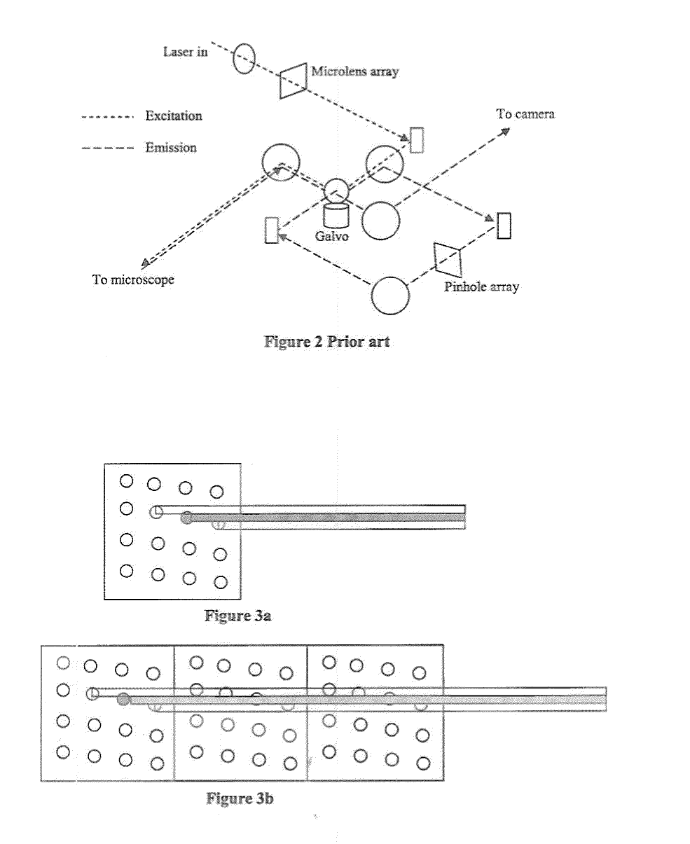

The result of combining these two techniques is an improvement of the throughput efficiency of the 2-D Array laser confocal scanner 10 and a reduction in the random ‘striping’ due to the presence of any imperfections that may appear in a single repeat pattern (FIGS. 3a and 3b). Careful initial design and selection of the manufacturing process make it unlikely that the same imperfection will appear in every repeat of the pattern, therefore the effect of a single imperfection is reduced by a factor of 1/n where n is the number of repeat patterns in the scan sweep. Since all repeat patterns scan over the sample plane for each image detected, image to image fluctuations are also eliminated.

In accordance with a second feature, the coherency effects that give rise to a regular pattern of ‘striping’ in the detected images due to the scanning of the illumination source intensity distribution across the sample plane with the scanning of the microlens generated points across the image is eliminated. The introduction of a second galvanometer mirror 24 and drive motor 25 into the illumination path (FIG. 5c), between the laser beam 18 and the input side of the microlens array 12, such that it is perfectly synchronised with the first galvanometer mirror 14 and that the rotation of the second galvanometer mirror is arranged to descan the illumination source, causing the illumination source to remain stationary at the scanned sample plane (FIG. 5b) while the microlens generated spots continue to be scanned over the sample plane. This reduces the appearance of the pattern of ‘striping’ in the detected images.

A third disclosed feature for curing the coherency artefact is to reduce the degree of coherency in the input illumination beam by inserting a small angle diffuser 26 prior to the illumination reaching the microlens array 12. To ensure that the diffuser does not introduce additional patterns in the illumination of the microlens array, the diffuser can be in the form of a disc rotated by a motor such that any patterns formed by the diffuser are randomised over the image plane during the duration of the exposure time of the image detection device.

A fourth disclosed feature introduces beam shaping optics into the illumination beam prior to the microlens array to correct the Gaussian intensity distribution and make it more uniform which also results in a reduction of potential ‘striping’ in the image (FIG. 7). Such correcting optics may take a variety of forms such as a flat top condenser 30; their only drawback is that they tend to be wavelength specific and therefore more useful in systems that operate at one wavelength or do not require rapid illumination wavelength switching.

A fifth disclosed feature changes the characteristics of a beam expander 32 upstream of the input side of the microlens array to trade reduced Gaussian shading for reduced intensity at the microlenses that also shows an improvement in the ‘striping’ in the image but at the expense of reduced captured image intensity. An appropriate balance between illumination throughput and Gaussian shading is necessary.

A sixth disclosed feature adapts the selectable size confocal aperture array to use air in place of oil (optical fluid) between the fixed 40 and moving plates 42 and is designed to maintain a small constant separation between the plates. Sliding the moving plate along one axis permits a selected aperture from an array of different sized apertures to be aligned with the aperture in the fixed plate. The fixed and sliding aperture plates are mounted so as to be recessed below the surface of their respective plate carriers, thus the surfaces of the aperture plates are prevented from rubbing against each other, thus eliminating a potential cause of damage.

1-17. (canceled)

18. A laser confocal scanning microscope comprising:
a laser light source for emitting laser light at one or more different wavelengths;
a laser beam expander for expanding said emitted laser light into a larger diameter laser beam;
a first galvanometer mirror for scanning and directing said laser beam through a microscope into a scanned sample plane, and for de-scanning a return light from the scanned sample plane,
an array of microlenses positioned between said laser beam expander and said first galvanometer mirror, a pattern of microlenses in said array being arranged in a form of at least two sub-patterns of microlenses, constructed and orientated such that a single scan of said first galvanometer mirror causes each microlens of a single sub-pattern of said array to trace a separate scan line across said sample plane,
an array of confocal apertures, which duplicates the pattern of said array of microlenses pre-aligned such that each confocal aperture of said array of confocal apertures coincides optically with a matching microlens in said array of microlenses;
a dichromatic mirror or a beam splitter, positioned between said first galvanometer mirror and said array of microlenses for separating said return light from the sample plane from said emitted laser beam and directing said return light to said array of confocal apertures;
an image detector, wherein an arrangement of said array of confocal apertures and of said first galvanometer mirror is such that light transmitted by said array of confocal apertures is directed to a rear face of said first galvanometer mirror, which is also a mirror, and as a result is scanned into said image detector to form an image of said sample plane;
a servo drive for driving said first galvanometer mirror to scan said laser beam emerging from said array of microlenses over said sample plane, to descan said returned light from said sample plane, and to rescan said light passing through said confocal apertures into said image detector;
a modulator for modulating the intensity of said laser beam such that the laser beam is blanked during a change of direction of said galvanometer scan, thus permitting said galvonometer scan to change direction while a sub-pattern is superimposed on said sample plane, and an amplitude of the galvanometer scan across said sample plane being arranged such that an entire sample plane is scanned by a change from superimposition on said sample plane of a first sub-pattern to a second sub-pattern;
a second galvanometer mirror positioned in the emitted laser beam upstream of said laser beam expander and arranged to scan said laser beam over said array of microlenses,
a control for driving said first galvanometer mirror that also drives said second galvanometer mirror to scan the laser beam over said array of microlenses, such that the scans of the first and second galvanometer mirrors are synchronized such that the illumination from the laser light source remains centered on that part of the said array of microlenses that is currently being scanned into the sample plane and said first galvanometer mirror descans the emitted laser beam causing it to remain stationary in the sample plane.

19. The laser confocal scanning microscope according to claim 18 wherein said array of confocal apertures is a fixed, selectable or adjustable array of confocal apertures of a generally circular shape.

20. The laser confocal scanning microscope according to claim 18, wherein each of the at least two sub-patterns of microlens and confocal aperture arrays are spatial duplicates, such that a single galvanometer sweep scans the sample plane multiple times depending on a number of pattern duplications.

21. The laser confocal scanning microscope according to claim 18 wherein said intensity modulation means is an acousto optical modulator (AOM), an acousto optical tuneable filter (AOTF), an adjustable micro mirror array, a motorized neutral density disc, or a modulator for directly modulating the laser light source.

22. The laser confocal scanning microscope according to claim 18 wherein said laser light source includes means to modify a coherency in the sample scanning beam comprising a small angle diffuser that is inserted into the laser beam in order to reduce coherency effects of the laser light at an output of said array of microlenses.

23. The laser confocal scanning microscope according to claim 22 wherein said small angle diffuser is rotatably mounted such that it does not introduce stationary illumination shading patterns into the sample plane.

24. The laser confocal scanning microscope according to claim 18 wherein said laser light source includes means to modify the illumination intensity distribution over said sample comprising:
a beam shaping optic that is inserted into the emitted laser light beam path, or
a Gaussian neutral density filter matching an intensity distribution of said laser beam that is inserted into the laser light path, or
a means for changing characteristics of said laser beam expander that is provided to increase the beam expansion in order to reduce a Gaussian intensity shading.

25. The laser confocal scanning microscope according to claim 18 wherein said array of confocal apertures includes means to modify the confocality of the scanned image comprising an additional plate containing multiple sets of arrays of apertures smaller than the apertures in said array of confocal apertures and positioned immediately adjacent and parallel to the said array of confocal apertures;
said additional plates separated by a small air gap; and
a control system that is adapted to slide said additional aperture plate to select any one of the sets of aperture arrays, thus controlling the degree of confocality and throughput of the microscope.

26. The laser confocal scanning microscope according to claim 18 wherein said control for the first and second galvanometer mirrors and/or said modulator comprises an electronic control system comprising hard wired logic, a digital signal processor, a microprocessor, a computer or similar computational device.

27. The laser confocal scanning microscope according to claim 18 wherein said laser light source includes a multi-line laser, a tuneable laser, and/or an array of lasers emitting at various wavelengths, arranged to provide collinear laser beams.

28. The laser confocal scanning microscope according to claim 18 wherein a laser light from said laser light source passes through free space to the confocal scanner beam path or is coupled by a rigid or flexible optical light guide.

29. The laser confocal scanning microscope according to claim 28 wherein the optical light guide is an optical fiber.

30. In the operation of a laser confocal scanning microscope a method of improving the light throughput, comprising:
providing at least two sub-patterns in each of a microlens and a confocal aperture array;
illuminating said microlens array with a laser beam;
rotating a first galvanometer mirror to direct a laser light emitted from the microlens array and bi-directionally scan said emitted laser light over a sample plane and descan a return light from the sample plane and direct said return light into a confocal aperture array;
modulating an illuminating laser beam intensity to blank the illumination intensities while the bidirectional scan changes direction with one of the at least two sub-patterns of microlenses superimposed over the sample plane; and
rotating a second galvanometer mirror driven in synchronism with the first galvanometer mirror such that the illuminating laser beam remains centered on that part of the microlens array that is currently being scanned into the sample plane by the first galvanometer mirror.
